(19) United States
(12) Patent Application Publication
(10) Pub. No.: US 2011/0287324 A1
(43) Pub. Date: Nov. 24, 2011

(54) SURFACE MODIFIED GLASS FIBERS

(75) Inventors: Mohan Rajaram, Albany, OR (US); George C. Zguris, Canterbury, NH (US)

(73) Assignee: Hollingsworth & Vose Company, E. Walpole, MA (US)

(21) Appl. No.: 12/851,107

(22) Filed: Aug. 5, 2010

Related U.S. Application Data
(60) Provisional application No. 61/347,165, filed on May 21, 2010.

(51) Int. Cl. H01M 2/16; C03C 13/00

(52) U.S. Cl. 429/246; 501/35; 429/247

(57) ABSTRACT

A composition including glass fibers with a surface atomic concentration of oxygen in sp3 bonds with silicon of at least about 34% wherein the fibers are formed into a battery separator.

### CROSS REFERENCE TO RELATED APPLICATIONS

The present application claims priority to U.S. Provisional Patent Application No. 61/347,165 filed on May 21, 2010, the entire contents of which is incorporated herein by reference.

### BACKGROUND OF THE INVENTION

Operation and efficiency of batteries involves many complex electro-chemical reactions. In particular, valve regulated lead acid (“VRLA”) batteries are extremely complex and involve many aspects. One such aspect is the generation of oxygen and hydrogen in the cell during cell charging. In particular, oxygen and hydrogen are generated during overcharging of a battery at the positive and negative electrodes respectively. The ability of oxygen and hydrogen to recombine to form water within the battery is an aspect of battery design and manufacture that influences the overall quality and operation of a battery. Oxygen transport, in particular, within the battery influences the rate at which oxygen and hydrogen recombine. Generally, because oxygen is poorly soluble in the electrolyte solutions and diffuses slowly to and from the liquid phase, oxygen transport is the limiting step in recombination. Improvements in oxygen transport improve various performance aspects of a battery.

### SUMMARY OF THE INVENTION

In various aspects, the present invention includes compositions including glass fibers with a surface atomic concentration of oxygen in sp3 bonds with silicon of at least about 34%, wherein the fibers are in the form of a battery separator.

In some embodiments, the fibers include between about 50 weight percent and about 75 weight percent silica, between about 1 weight percent and about 5 weight percent aluminum oxide, and less than about 25 weight percent sodium oxide;

In some embodiments, the concentration of oxygen in sp3 bonds with silicon is measured by XPS. In some embodiments, the atomic concentration of oxygen in sp3 bonds with silicon is measured to a depth of between about 100 and 150 Angstroms from the surface of the fiber.

In some embodiments, the surface atomic concentration of oxygen in sp3 bonds with silicon is at least about 35%, at least about 36%, at least about 37%, at least about 38%, or at least about 39%.

In some embodiments, the atomic concentration of oxygen bonded with silicon is at least about 56 percent, at least about 58 percent, at least about 60 percent, at least about 62 percent or at least about 64 percent.

In some embodiments, the fibers include between about 60 weight percent and about 70 weight percent silica. In some embodiments, fibers include between about 0.5 weight percent and about 30 weight percent bismuth oxide.

In some embodiments, the fibers have an average diameter of about 0.8 micrometers. In some embodiments, the fibers have an average diameter between about 0.6 μm and about 8 μm. In some embodiments, the fibers have an average diameter between about 0.7 μm and about 1.5 μm. In some embodiments, the fibers have an average diameter of about 0.92 μm, of about 1.1 μm or of about 1.4 μm. In some embodiments, the fibers have an average diameter in the range of about 2.5 μm to about 10 μm.

In some embodiments, the battery separator has an average thickness of between about 0.25 mm and about 4 mm, before placement in a battery. In some embodiments, the battery separator has a surface area between about 1.0 m²/g and about 2.5 m²/g. In some embodiments, the battery separator has a surface area between about 1.3 m²/g and about 1.6 m²/g. In some embodiments, the battery separator further includes organic fibers. In some embodiments, the battery separator further includes bi-component fibers.

In some embodiments, the battery separator has a grammage of between about 15 gsm and about 100 gsm. In some embodiments, the battery separator has a grammage of between about 140 gsm and about 500 gsm.

In various aspects, the present invention includes a battery, including a first electrode, a second electrode, wherein at least one of the first and second electrodes includes lead, a separator between the first and second electrodes, wherein the separator includes glass fibers with a surface atomic concentration of oxygen in sp3 bonds with silicon of at least about 34%, and an electrolytic solution. In some embodiments, the battery separator is a non-woven mat.

In various aspects, the present invention includes a composition including glass fibers with a surface atomic concentration of oxygen in sp3 bonds with silicon of at least about 34%; wherein the fibers are in the form of pasting paper. In some embodiments, the concentration of oxygen in sp3 bonds with silicon is measured by XPS.

### BRIEF DESCRIPTION OF THE DRAWINGS

FIG. 1 shows the typical reactions and transport of the oxygen cycle within a battery.

FIG. 2 shows the current profile during a recharging cycle.

FIG. 3 shows a comparison of the voltage profile of a battery during recharging with the gas flow vented from the battery during the same time.

FIG. 4 shows the difference in electrode potentials between a flooded battery and a VRLA battery with oxygen recombination cycle.

FIG. 5 shows the voltage profile of a VRLA battery with recombination (thin line), and flooded battery (heavy line).

FIG. 6 shows the current profile of a test cell with and without standard glass fibers.

FIG. 7 shows the current profile of a test cell with and without standard enhanced oxygenated glass fibers.

FIG. 8 shows O1s Peak fit profile from x-ray photoelectron spectroscopy (“XPS”) analysis of the surface of enhanced oxygenated glass fibers.

FIG. 9 shows a typical survey scan for XPS analysis of enhanced oxygenated glass fibers.

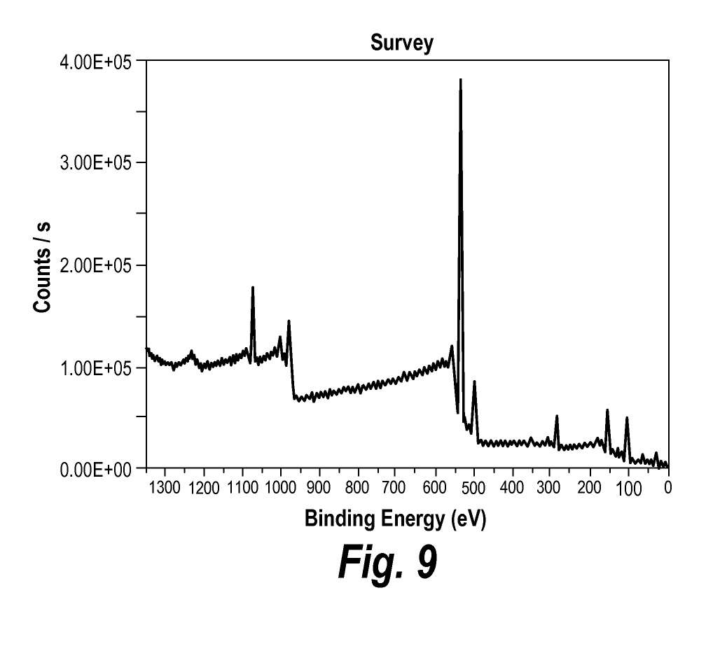

### DETAILED DESCRIPTION OF VARIOUS EMBODIMENTS OF THE INVENTION

### Overview of Overcharging & Oxygen Recombination in Lead Acid Batteries

Overcharge conditions in a battery can affect battery life and performance Overcharge is the amount of extra charge needed to overcome inefficiencies in recharging the battery. The more efficient the battery is, the less overcharge is required. The discharge reactions of a battery (e.g., a lead-acid battery) are well known:

Anode: Pb(s)+HSO₄⁻(aq)→PbSO₄(s)+H⁺+2e⁻

Cathode: PbO₂(s)+3H⁺(aq)+HSO₄⁻(aq)+2e⁻→PbSO₄(s)+2H₂O

Net: Pb(s)+PbO₂(s)+2H⁺(aq)+2HSO₄⁻(aq)→2PbSO₄(s)+2H₂O

And, the reverse reactions for recharging the battery:

PbSO₄(s)+H⁺+2e⁻→Pb(s)+HSO₄⁻(aq)

PbSO₄(s)+2H₂O→PbO₂(s)+3H⁺(aq)+HSO₄⁻(aq)+2e⁻

Once the battery has reached full charge, overcharging condition is present and the contents of the battery (e.g., water in the electrolyte) undergo the following reactions at the positive and negative electrode, respectively:

2H₂O→O₂+4H⁺+4e⁻ (O₂ generation from the positive electrode)

4H⁺+4e⁻→H₂ (H₂ generation from the negative electrode)

O₂+4H⁺+4e⁻->2H₂O (O₂ recombination at the negative electrode)

A sulfate intermediate is formed at the negative electrode during recombination.

Reactions around the intermediate can be expressed as:

2Pb+O₂+2H₂SO₄=>2PbSO₄+2H₂O

2PbSO₄+4H⁺4e⁻=>2Pb+2H₂SO₄

In a VRLA battery, for example, the internal environment is controlled by a valve for venting, the valve vents gas (e.g., hydrogen, oxygen) from the battery as pressure builds. The valve is a pressure relief valve, only opening when the internal battery pressure reaches a threshold. When the internal pressure in the battery is below this threshold the valve prevents either gas from escaping. The generated O₂ can diffuse from the positive electrode to the negative electrode, and recombine with the H₂ to form water.

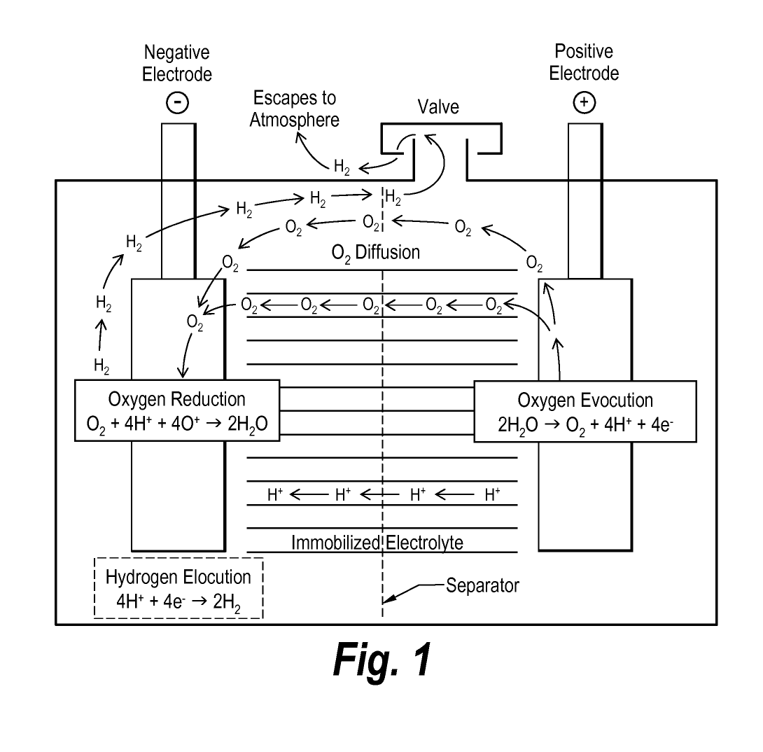

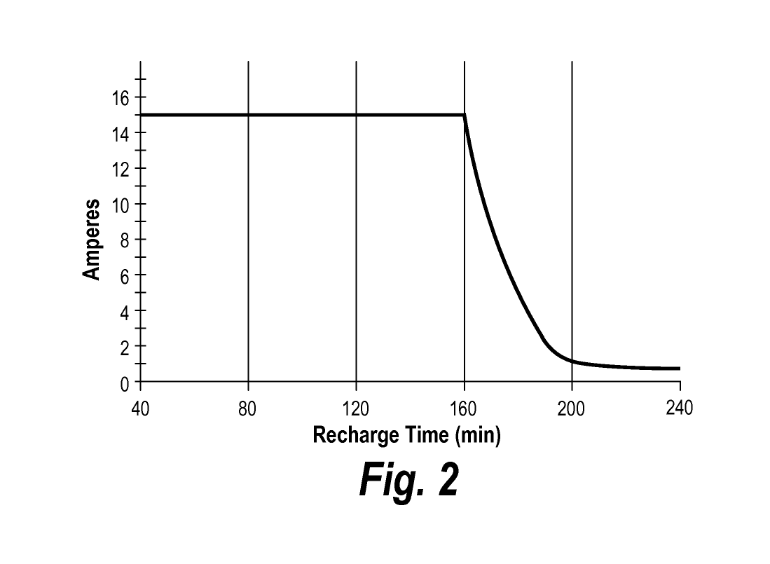

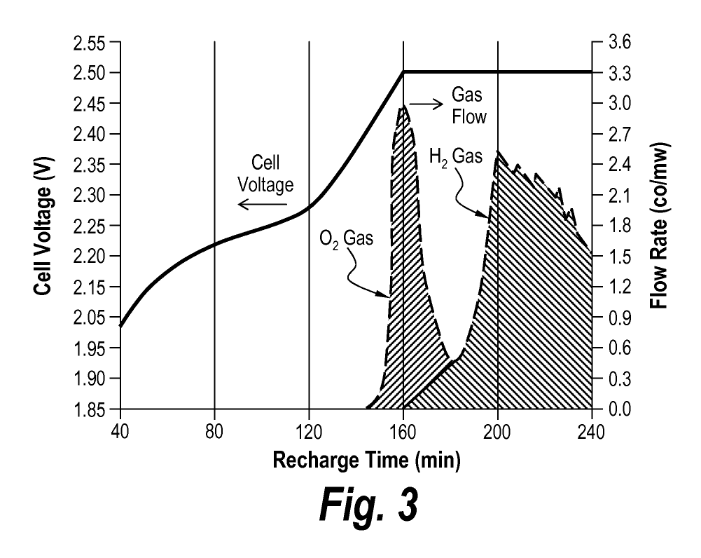

FIG. 1 illustrates the typical reactions and transport of the oxygen cycle within a battery, in this case, a VRLA battery. FIG. 2 illustrates the current profile during a recharging cycle. Notably the current is constant until the time reaches a point just prior to 160 minutes, and the current drops. The drop signifies the end of the “bulk charging” period and commencement of the “overcharging” condition. The overcharging period is a dynamic situation, as described above and shown in FIG. 1. FIG. 3 compares the voltage profile of a battery during recharging with the gas flow developed and vented from the battery during the same time FIG. 3 illustrates the gas generation during the overcharging condition. As the voltage stabilizes at about 2.50 volts, after nearly 160 minutes of charging, gas starts to vent from the cell. Gas analysis shows that the first spike in gas flow is mostly oxygen. The decrease in vented oxygen is likely due to the oxygen recombination reaction at the negative electrode. The second spike in vented gas flow is from hydrogen generation at the negative electrode.

The ability of oxygen and hydrogen to recombine in the battery governs several facets of the battery performance and safety. Pure oxygen and hydrogen are explosive gases, and thus recombination is important to avoid an explosive battery. A low level of recombination of oxygen and hydrogen also negatively affects the charge acceptance of the battery. Gassing at the negative electrode is indicative of an exponentially rising negative electrode voltage which adds to the positive electrode voltage to reach the voltage limit electrically allowed. To keep the battery voltage under the voltage limit, current flow is reduced and less charge can be accepted by the battery, thus reducing charge acceptance. A low level of recombination may also reduce cycle life (e.g. cycle life being the number of charge-discharge cycles before a specific level of capacity is irreversibly lost, the threshold of capacity loss varies from application to application). As described above, less recombined oxygen gas allows the negative electrode potential to reach hydrogen gassing state. Hydrogen evolution and hydrogen escape occurs since hydrogen is not recombined under normal conditions and leaves the system resulting in water loss. Water loss reduces a VRLA battery's useful capacity which in turn limits the amount of cycles the battery can accumulate over its lifetime.

The desirable effects of improved oxygen recombination must be balanced by its negative effects on the battery as well. The recombination reaction is an exothermic reaction, and drives up the temperature in the battery, which in turn further increases the rate of oxygen recombination. Adding to the rate of oxygen recombination is the content of water in the battery, which is also affected by the rate of gas generation (e.g., by overcharging). As the water content in the battery decreases, the rate of oxygen recombination increases, further increasing the heat generated. Water loss also increases electrical resistance in the cell, further increasing the heat. An optimal electrolyte saturation level occurs when gas can transfer freely, but not excessively which occurs if an excessive amount of water is lost from the system.

The rate of oxygen recombination is largely determined by the rate of oxygen transport within the cell. For example, in conventional, liquid, electrolyte batteries oxygen is poorly soluble in the electrolyte, the diffusion rate for oxygen through and from the electrolyte is very slow, thus the recombination rate is very slow, so much so that recombination is considered by one of ordinary skill in the art to not occur at all. In VRLA batteries, particularly those with glass mat separators, the reaction is typically faster, as the glass saturation level decreases (i.e., the amount of glass fibers in the separator and battery as a whole) aide oxygen transport through the separator. Non-saturated areas, provided by the battery separator, aide oxygen transport within the cell, and thus improve oxygen recombination in a VRLA battery as compared to a flooded battery. The silica surfaces of the glass fiber separator are shown to improve transport as well in various embodiments of the disclosed invention.

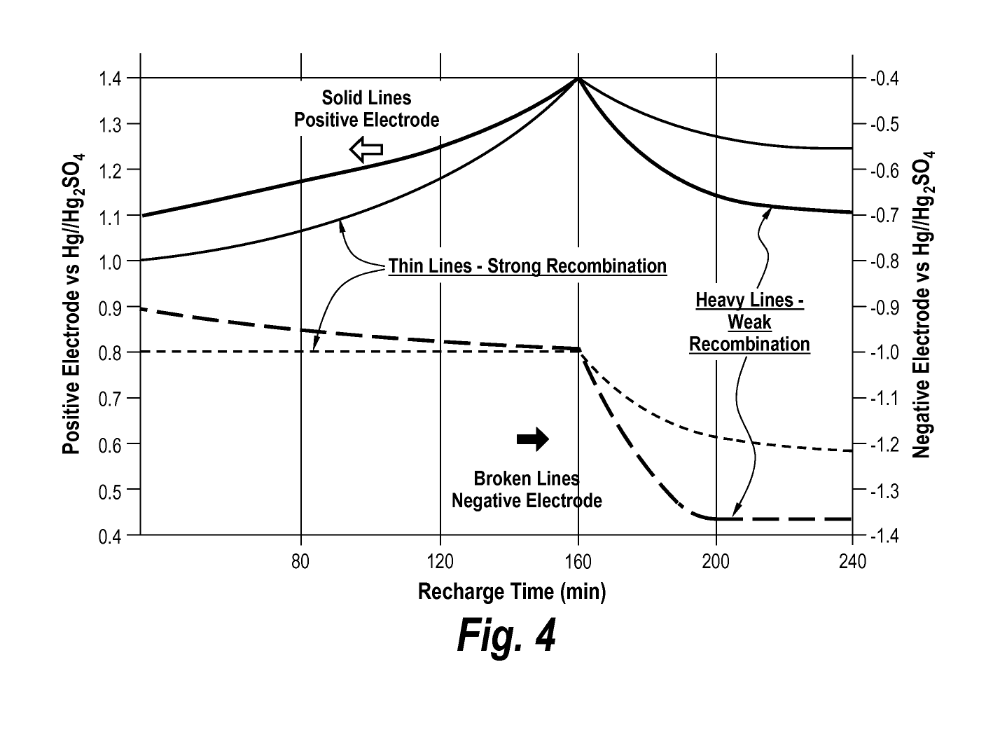

As noted above, oxygen recombination affects the cycling of a battery. Batteries with poor oxygen recombination show lower positive electrode polarization and electrical potential. High positive electrode potentials accompany superior cycling performance. FIG. 4 illustrates the difference in electrode potentials between flooded batteries and VRLA batteries with oxygen recombination cycle. The thinner lines denote the electrode potential for both the positive and negative electrode (upper and lower plots, respectively). The heavier lines denote the electrode potential for a standard flooded battery. In both the positive and negative electrode the potentials of the recombination battery are higher, yielding a battery with superior cycling ability, as compared to the flooded battery.

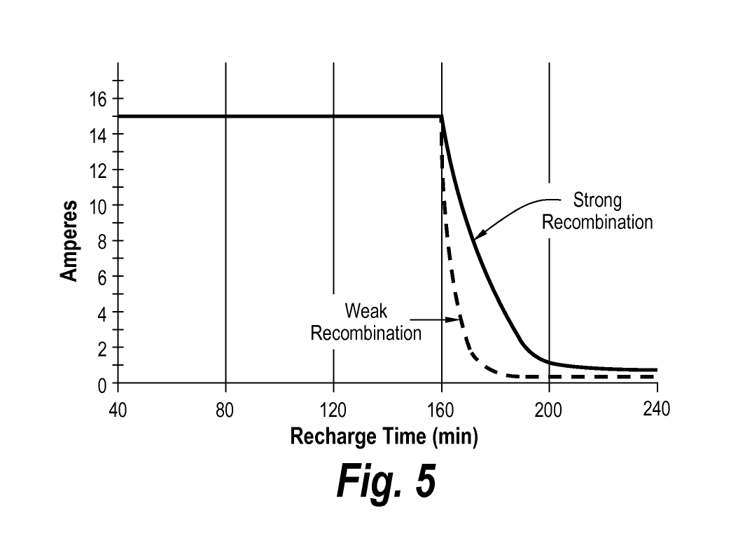

Additionally, a battery with superior oxygen recombination will have higher charge acceptance. Illustrated in FIG. 5 is the voltage profile of a VRLA battery with recombination (thin line), and flooded battery (i.e., with no, or poor, oxygen recombination, the heavy line). Again, the VRLA battery with oxygen recombination shows a higher charge acceptance at the negative electrode indicated by the higher voltage after about 160 minutes (i.e., after a full charge is completed).

The characteristics of the battery separator can influence the rate of recombination of oxygen, and thus the efficiency and performance of the battery. Not only can greater transference of oxygen within the battery lead to a safer battery with improved performance for the reasons described above (i.e., improved cycling, greater electrode potential, higher charge acceptance, etc.) but additional electrolyte can be added to the battery as compared to a battery with a separator that has inferior oxygen transport capability.

One method to improve oxygen transference or oxygen transfer within the battery is to provide a separator made of glass fibers with an enhanced silicon-oxygen bond concentration, on the surface of the fibers, a surface modified fiber. The bond concentration represents the percentage of silicon-oxygen bonds on the surface of the fiber. Silicon and oxygen can form two types of bonds. The first type of bond, referred to as an sp3 bond, is formed from sp3 hybrid molecular orbitals and forms in SiO₂. The second type, referred to as a 2p bond, is formed from 2p molecular orbitals and forms in SiO. As described below, x-ray photoelectron spectroscopy (“XPS”) is typically used to characterize and quantify the atomic bonds. The silicon-oxygen sp3 bonds have a characteristic energy of 532.7 eV. The silicon-oxygen 2p bond is characteristic bond energy of 103.5 eV, as measured by XPS. The atomic concentration of oxygen in sp3 bonds with silicon ranges between about 30 to about 50 percent. The atomic concentration of oxygen in 2p bonds with silicon ranges between about 22 to about 24 percent.

In some embodiments, the quantity of sp3 bonds can be increased based on the conditions during glass fiber formation. As described below, an oxygen enriched combustion stream increases the silicon-oxygen bond concentration on the surface of the fiber, as measured by XPS. In particular, the oxygen rich fuel leads to a higher concentration of sp3 bonds.

The remaining bond concentration of the glass fiber surface includes bonds between oxygen and other atoms within the glass (e.g., aluminum, sodium, calcium, etc.). Also part of the fiber's atomic structure are dangling bonds, in which oxygen atoms have an open coordination site. For example, an oxygen atom is bound at one site to a silicon, however, the other potential bond of the oxygen is not completed. This dangling bond results in a negative charge on the oxygen atom. The oxygen atom will then interact with any positively charged species via Van der Waals' forces. Without being bound to any particular theory, it is thought that the dangling bonds create a surface environment that allows oxygen molecules to more easily travel along the fiber by hopping mechanism. The enhanced SiO₂ bond content, in some embodiments, also includes higher concentration of dangling bonds, evidenced by the XPS shoulder at 530.6 eV corresponding to charge oxygen in a silicon-oxygen-sodium (Si—O⁻—Na⁺) arrangement.

Many glass fibers, including all microglass fibers analyzed in Table 2 below, made in a traditional manner have an atomic concentration of oxygen in sp3 bonds with silicon of about, or less than about, 33.4 percent. The glass fibers made in an oxygen rich environment, described in further detail below and referred to as surface modified fibers, display an atomic concentration of oxygen in sp3 bonds with silicon of at least about 34 percent, (the sp3 bond concentration) as measured by XPS. See, e.g., Table 2. Typically the surface depth analyzed in XPS is between about 100 and about 150 Angstroms, and in some embodiments up to about 200 Angstroms. In some embodiments, the surface atomic concentration of oxygen in sp3 bonds with silicon is at least about 35 percent, as measured by XPS. In some embodiments, the surface atomic concentration of oxygen in sp3 bonds with silicon is at least about 36 percent, as measured by XPS. In some embodiments, the surface atomic concentration of oxygen in sp3 bonds with silicon is at least about 37 percent, as measured by XPS. In some embodiments, the surface atomic concentration of oxygen in sp3 bonds with silicon is at least about 38 percent, as measured by XPS. In some embodiments, the surface atomic concentration of oxygen in sp3 bonds with silicon is at least about 39 percent, as measured by XPS. In some embodiments, the surface atomic concentration of oxygen in sp3 bonds with silicon is at least about 40 percent, as measured by XPS. In some embodiments, the surface atomic concentration of oxygen in sp3 bonds with silicon is at least about 41 percent, as measured by XPS. In some embodiments, the surface atomic concentration of oxygen in sp3 bonds with silicon is at least about 42 percent, as measured by XPS. In some embodiments, the surface atomic concentration of oxygen in sp3 bonds with silicon is at least about 45 percent, as measured by XPS. In some embodiments, the surface atomic concentration of oxygen in sp3 bonds with silicon is at least 50 percent. In some embodiments, the surface atomic concentration of oxygen in sp3 bonds with silicon is at most 50 percent. In some embodiments, the surface atomic concentration of oxygen in sp3 bonds with silicon is at most 45 percent.

Total silicon-oxygen bond concentration can also be measured by XPS, as described above, i.e., the total bond concentration is the total of sp3 bonds and 2p bonds between silicon and oxygen. In some embodiments, the atomic concentration of oxygen in any bond with silicon is at least about 56 percent. In some embodiments, the atomic concentration of oxygen in any bond with silicon is at least about 57 percent. In some embodiments, the atomic concentration of oxygen in any bond with silicon is at least about 58 percent. In some embodiments, the atomic concentration of oxygen in any bond with silicon is at least about 59 percent. In some embodiments, the atomic concentration of oxygen in any bond with silicon is at least about 60 percent. In some embodiments, the atomic concentration of oxygen in any bond with silicon is at least about 61 percent. In some embodiments, the atomic concentration of oxygen in any bond with silicon is at least about 62 percent. In some embodiments, the atomic concentration of oxygen in any bond with silicon is at least about 63 percent. In some embodiments, the atomic concentration of oxygen in any bond with silicon is at least about 64 percent. In some embodiments, the atomic concentration of oxygen in any bond with silicon is at least about 65 percent. In some embodiments, the atomic concentration of oxygen in any bond with silicon is at least about 66 percent. In some embodiments, the atomic concentration of oxygen in any bond with silicon is at least about 67 percent. In some embodiments, the atomic concentration of oxygen in any bond with silicon is at least about 68 percent. In some embodiments, the atomic concentration of oxygen in any bond with silicon is at least about 69 percent. In some embodiments, the atomic concentration of oxygen in any bond with silicon is at least about 70 percent. In some embodiments, the atomic concentration of oxygen in any bond with silicon is at least about 71 percent. In some embodiments, the atomic concentration of oxygen in any bond with silicon is at least about 72 percent. In some embodiments, the atomic concentration of oxygen in any bond with silicon is at least about 73 percent. In some embodiments, the atomic concentration of oxygen in any bond with silicon is at least about 74 percent.

One method for obtaining fibers with enhanced sp3 bond concentration at the surface is to make the glass fiber with a lean or oxygen enriched combustion flame. The fibers are typically manufactured in a flame attenuated flame blower. Other fiberization methods, known to those of ordinary skill in the art, may be employed to manufacture fibers with enhanced sp3 bonding at the surface of the fiber (e.g., rotary fiberizers, control attenuated technology, etc.) Turning to the flame attenuated methods, changing the hydrocarbon fuel (e.g. natural gas) to air ratio from the traditional, stoichiometrically proportioned, ratio of 1:10 to a ratio lean in hydrocarbon fuel by adding more air or oxygen to the feed results in an increased oxidizing environment in the flame. Oxygen can be directly added to either the air or hydrocarbon fuel line. As used herein, air refers to the oxidant source in the combustion reaction, whether atmospheric air, or air with added oxygen. In some embodiments, the concentration of oxygen in the air is between about 20.9 volume percent and about 100 volume percent. In some embodiments, the concentration of oxygen in air ranges between 7.5 volume percent to about 20.9 volume percent. Without being bound to a particular theory, it is thought that the oxygen rich flame facilitates the formation of more sp3 bonds on the surface of the glass fiber, as opposed to stoichiometrically proportioned flame.

In some embodiments, the ratio of fuel to air is about at least 1:10, about at least 1:15, about at least 1:20, about at least 1:25, about at least 1:30, about at least 1:40, about at least 1:50, about at least 1:60, about at least 1:75, about at least 1:80, about at least 1:90, or about at least 1:100. In some embodiments, oxygen is added to either the air or combustion stream. In some embodiments, the air may be up to about 25% O₂ by volume. In some embodiments, the air may be up to about 23.5% O₂ by volume. In some embodiments, the air may be up to about 22.5% O₂ by volume. In some embodiments, the air may be up to about 21.5% O₂ by volume. In some embodiments, the air may be up to about 20.5% O₂ by volume. In some embodiments, the air may be up to about 17.5% O₂ by volume. In some embodiments, the air may be up to about 15% O₂ by volume. In some embodiments, the air may be up to about 12.5% O₂ by volume. In some embodiments, the air may be up to about 10% O₂ by volume. In some embodiments, the air may be up to about 7.5% O₂ by volume. In some embodiments, the air may be up to about 5% O₂ by volume.

In some embodiments, the air may be between about 23.5% O₂ and about 25% O₂. In some embodiments, the air may be between about 21.5% O₂ and about 23.5% O₂. In some embodiments, the air may be between about 20.5% O₂ and about 21.5% O₂. In some embodiments, the air may be between about 21.5% O₂ and about 25% O₂. In some embodiments, the air may be between about 20.5% O₂ and about 23.5% O₂. In some embodiments, the air may be between about 15% O₂ and about 17.5% O₂. In some embodiments, the air may be between about 12.5% O₂ and about 15% O₂. In some embodiments, the air may be between about 10% O₂ and about 15% O₂. In some embodiments, the air may be between about 7.5% O₂ and about 12.5% O₂.

In some embodiments, the O₂ is expressed as additional volumetric percentage over standard atmospheric volumetric percentage of oxygen in air. For example, a 2.7 volume percent enrichment of O₂ gives a final volume percentage of 23.6 oxygen in the fuel, based on 20.9 volume percent of air being oxygen. In some embodiments, the volume addition of oxygen is at most about 1 percent by volume. In some embodiments, the volume addition of oxygen is at most about 1.5 percent by volume. In some embodiments, the volume addition of oxygen is at most about 2 percent by volume. In some embodiments, the volume addition of oxygen is at most about 2.5 percent by volume. In some embodiments, the volume addition of oxygen is at most about 2.7 percent by volume. In some embodiments, the volume addition of oxygen is at most about 3 percent by volume. In some embodiments, the volume addition of oxygen is at most about 3.5 percent by volume. In some embodiments, the volume addition of oxygen is at most about 4 percent by volume. In some embodiments, the volume addition of oxygen is at most about 4.5 percent by volume. In some embodiments, the volume addition of oxygen may be between about 1 percent by volume and about 2 percent by volume. In some embodiments, the volume addition of oxygen may be between about 2 percent by volume and about 3 percent by volume. In some embodiments, the volume addition of oxygen may be between about 3 percent by volume and about 4 percent by volume. In some embodiments, the volume addition of oxygen may be between about 1.5 percent by volume and about 2.5 percent by volume. In some embodiments, the volume addition of oxygen may be between about 2.5 percent by volume and about 3.5 percent by volume. In some embodiments, the volume addition of oxygen may be between about 3.5 percent by volume and about 4.5 percent by volume.

### XPS

X-ray photoelectron spectroscopy (“XPS”) is a quantitative, analytical method that measures the elemental composition of a surface of a material. Generally, this is accomplished by irradiating the surface with X-ray radiation, and measuring the kinetic energy and quantity of photoelectrons that are ejected from the material by the X-ray. The kinetic energy of the electrons varies by the bond energy (i.e., elements) from which the electron is ejected from. For example, electrons with 532 eV of energy in XPS correspond to the binding energy of sp3 bonds in silicon-oxygen bonds. The quantity of electrons indicates the relative quantity of the particular materials from which the electrons were ejected. XPS data presented herein were generated on a ThermoScientific ESCALAB 250. Pass energy for survey scans was 150 eV, and 50 eV for multiplex scans in compositional analysis. The device used monochromatized aluminum as the X-ray source. The spot size for analysis was 400 μm. Binding energy scales were adjusted in spectra plots to hydrocarbon in C1s=284.8 eV. One of ordinary skill in the art will recognize that additional techniques related to XPS analysis (e.g., curve fitting, charge neutralization, etc.) may aide in analysis of particular materials and/or the use of particular instruments. Charge neutralization is used for nonconductive materials, such as glass fibers, to keep data consistent by grounding the sample and preventing electrical charge from building up on the surface.

### Fibers—Generally

Dimensions

In some embodiments, the fibers (such as microglass fibers and/or chopped glass fibers) contain (e.g., are formed entirely of) one or more glass materials. Various types of glass fibers can be used, such as glass fibers that are relatively inert to lead acid battery storage and use conditions.

The fibers can have various diameters. In some embodiments, the fibers have an average diameter of less than approximately 30 micrometers, e.g., from approximately 0.1 micrometers to approximately 30 micrometers. The average diameter can be greater than or equal to approximately 0.1 micrometers, approximately 0.2 micrometers, approximately 0.4 micrometers, approximately 0.6 micrometers, approximately 0.8 micrometers, approximately 1 micrometer, approximately 2 micrometers, approximately 3 micrometers, approximately 5 micrometers, approximately 10 micrometers, approximately 15 micrometers, approximately 20 micrometers, or approximately 25 micrometers; and/or less than or equal to approximately 30 micrometers, approximately 25 micrometers, approximately 20 micrometers, approximately 15 micrometers, approximately 10 micrometers, approximately 5 micrometers, approximately 3 micrometers, approximately 2 micrometers, approximately 1 micrometer, approximately 0.8 micrometers, approximately 0.4 micrometers or approximately 0.2 micrometers. Average diameters of the glass fibers may have any suitable distribution. In some embodiments, the diameters of the fibers are substantially the same. In other embodiments, average diameter distribution for glass fibers may be log-normal. However, it can be appreciated that glass fibers may be provided in any other appropriate average diameter distribution (e.g., a Gaussian distribution, a bimodal distribution).

The fibers can also have various lengths. In some embodiments, the fibers have an average length of less than approximately 75 millimeters, e.g., from approximately 0.0004 millimeter to approximately 75 millimeters. The average length can be greater than or equal to approximately 0.0004 millimeters, approximately 0.001 millimeters, approximately 0.01 millimeters, approximately 0.1 millimeters, approximately 0.50 millimeters, approximately 1 millimeter, approximately 5 millimeters, approximately 10 millimeters, approximately 15 millimeters, approximately 20 millimeters, approximately 25 millimeters, approximately 30 millimeters, approximately 40 millimeters, approximately 50 millimeters, approximately 60 millimeters, or approximately 70 millimeters; and/or less than or equal to approximately 75 millimeters, approximately 60 millimeters, approximately 50 millimeters, approximately 40 millimeters, approximately 30 millimeters, approximately 25 millimeters, approximately 20 millimeters, approximately 15 millimeters, approximately 10 millimeters, approximately 5 millimeters, approximately 1 millimeter, approximately 0.50 millimeters, approximately 0.1 millimeters, approximately 0.01 millimeters, approximately 0.001 millimeters, or approximately 0.0005 millimeters. The average length of a sample of fibers is determined by optical measure (e.g., microscopy, visually, scanning electron microscopy).

The dimensions of the fibers can also be expressed as an average aspect ratio. The average aspect ratio of a sample of fibers refers to the ratio of the average length of the sample of fibers to the average diameter (or width for fibers with non-circular cross sections) of the sample of fibers. In certain embodiments, the fibers have an average aspect ratio of less than approximately 10,000, for example, from approximately 5 to 10,000. The average aspect ratio can be greater than or equal to approximately 5, approximately 50, approximately 100, approximately 500, approximately 1,000, approximately 1,500, approximately 2,000, approximately 2,500, approximately 3,000, approximately 3,500, approximately 4,000, approximately 4,500, approximately 5,000, approximately 7,500, or approximately 9,000; and/or less than or equal to approximately 10,000, approximately 7,500, approximately 5,000, approximately 4,500, approximately 4,000, approximately 3,500, approximately 3,000, approximately 2,500, approximately 2,000, approximately 1,500, approximately 1,000, approximately 500, approximately 100, approximately 50 or approximately 10.

Examples of glass fibers that are suitable for various embodiments of the present invention include chopped strand glass fibers and microglass fibers. Chopped strand glass fibers and microglass fibers are known to those skilled in the art. One skilled in the art is able to determine whether a glass fiber is chopped strand or microglass by observation (e.g., optical microscopy, electron microscopy). Chopped strand glass may also have chemical differences from microglass fibers. In some cases, though not required, chopped strand glass fibers may contain a greater content of calcium or sodium than microglass fibers. For example, chopped strand glass fibers may be close to alkali free with high calcium oxide and alumina content. Microglass fibers may contain 10-15% alkali (e.g., sodium, magnesium oxides) and have relatively lower melting and processing temperatures. The terms refer to the technique(s) used to manufacture the glass fibers.

Such techniques impart the glass fibers with certain characteristics. In general, chopped strand glass fibers are drawn from bushing tips and cut into fibers. Microglass fibers are drawn from bushing tips and further subjected to flame blowing or rotary spinning processes. In some cases, fine microglass fibers may be made using a re-melting process. In this respect, microglass fibers may be fine or coarse. Chopped strand glass fibers are produced in a more controlled manner than microglass fibers, and as a result, chopped strand glass fibers will generally have less variation in fiber diameter and length than microglass fibers.

Compositions

In some embodiments, the disclosed glass fibers may include one or more of the following components in the following quantities: 50-75 weight percent SiO₂; 1-5 weight percent Al₂O₃; 0-30 weight percent Bi₂O₃; 3-7 weight percent CaO; 1-5 weight percent MgO; 4-9 weight percent B₂O₃; 0-3 weight percent each of ZrO₂ and K₂O; 9-20 weight percent of Na₂O; 0-2 weight percent NiO; 0-5 weight percent of each of ZnO and BaO; and 0-1 weight percent of each of Ag₂O, Li₂O and F₂O.

In some embodiments, the disclosed glass compositions may comprise one or more of the following components in the following quantities: 56-69 weight percent SiO₂; 2-4 weight percent Al₂O₃; 0.5-30 (e.g., 1-15) weight percent Bi₂O₃; 3-6 weight percent CaO; 2-4 weight percent MgO; 4-7 weight percent B₂O₃; 0.1-1.5 weight percent each of K₂O; 11.5-18 weight percent of Na₂O; 0-1 weight percent NiO; 0-3 weight percent of each of ZnO and ZrO₂; 0-0.1 weight percent of Ag₂O; 0-0.3 weight percent of Li₂O; 0-0.8 weight percent of F₂O; and 0-2 weight percent of BaO.

One of ordinary skill in the art will recognize that the bulk concentrations, or ingredient list, represents the bulk composition of the glass fiber composition. Further, the XPS data expressing relative concentrations of bond content concentration in atomic weight percent with reference to oxygen concentration at the surface of the fibers is not equivalent to the bulk concentrations of components of the glass fibers expressed in weight percent.

### Separators—Generally

The fibers described above can be formed into a separator. Generally, the separators are non-woven mats or bundles comprised of at least glass fibers disposed between the positive and negative plates in the battery. In some embodiments, the separator has a combination of chopped strand glass fibers and microglass fibers. In some embodiments, the separator may contain between about 0 weight percent to about 100 weight percent chopped strand glass fibers. In some embodiments, the separator may contain between about 5 weight percent to about 15 weight percent chopped strand glass fibers. In some embodiments, the separator may contain between about 0 weight percent to about 100 weight percent microglass fibers. In some embodiments, the separator may contain between about 85 weight percent to about 95 weight percent microglass fibers. In some embodiments, the separator may contain between about 85 weight percent to about 100 weight percent microglass fibers. The separator can be made using a papermaking type process (e.g., wet-laid, dry-laid, etc.). As a specific example, the separator can be prepared by a wet laid process, wherein, the separator may be formed by depositing a fiber slurry on a surface (such as a forming wire) to form a layer of intermingled fibers. The mixture (e.g., a slurry or a dispersion) containing the fibers in a solvent (e.g., an aqueous solvent such as water) can be applied onto a wire conveyor in a papermaking machine (e.g., an inclined former, a Fourdrinier, gap former, twin wire, multiply former, a Fourdrinier-cylinder machine, or a rotoformer) to form a layer supported by the wire conveyor. Additional types of fibers can be added to the slurry, as well as common additives. A vacuum is applied to the layer of fibers during the above process to remove the solvents from the fibers. The separator is then passed through the drying section, typically a series of steam heated rollers to evaporate additional solvent. Any number of intermediate processes (e.g., pressing, calendering, etc.) and addition of additives may be utilized throughout the separator formation process. Additives can also be added either to the slurry or to the separator as it is being formed, including but not limited to, salts, fillers including silica, binders, and latex. The additives may comprise between about 0% to about 30% by weight of the separator. During the separator forming process, various pH values may be utilized for the slurries. Depending on the glass composition the pH value may range from approximately 2 to approximately 4. Furthermore, the drying temperature may vary, also depending on the fiber composition. In various embodiments, the drying temperature may range from approximately 100° C. to approximately 700° C. The separator may comprise more than one layer, each layer comprising different types of fibers with different physical and chemical characteristics.

Alternatively or additionally, the fibers can include one or more other compositions. For example, the fibers can include non-glass fibers, natural fibers (e.g., cellulose fibers), synthetic fibers (e.g., polymeric, regenerated cellulose), ceramic or any combination thereof. Alternatively or additionally, the fibers can include thermoplastic binder fibers. Exemplary thermoplastic fibers include, but are not limited to, bi-component, polymer-containing fibers, such as sheath-core fibers, side-by-side fibers, “islands-in-the-sea” and/or “segmented-pie” fibers. Examples of types of polymeric fibers include substituted polymers, unsubstituted polymers, saturated polymers, unsaturated polymers (e.g., aromatic polymers), organic polymers, inorganic polymers, straight chained polymers, branched polymers, homopolymers, copolymers, and combinations thereof. Examples of polymer fibers include polyalkylenes (e.g., polyethylene, polypropylene, polybutylene), polyesters (e.g., polyethylene terephthalate), polyamides (e.g., nylons, aramids), halogenated polymers (e.g., polytetrafluoroethylenes), and combinations thereof.

The surface area of separator can range from approximately 0.5 m²/g to approximately 18 m²/g, for example, from approximately 1.3 m²/g to approximately 1.7 m²/g. The surface area can be greater than or equal to approximately 0.5 m²/g, approximately 1 m²/g, approximately 2 m²/g, approximately 3 m²/g, approximately 4 m²/g, approximately 5 m²/g, approximately 6 m²/g, approximately 7 m²/g, approximately 8 m²/g, approximately 9 m²/g, approximately 10 m²/g, approximately 12 m²/g, approximately 15 m²/g or approximately 18 m²/g, and/or less than or equal to approximately 18 m²/g, approximately 15 m²/g, approximately 12 m²/g, approximately 11 m²/g, approximately 10 m²/g, approximately 9 m²/g, approximately 8 m²/g, approximately 7 m²/g, approximately 6 m²/g, approximately 5 m²/g, approximately 4 m²/g, approximately 3 m²/g, approximately 2 m²/g, approximately 1 m²/g, or approximately 0.6 m²/g. The BET surface area is measured according to method number 8 of Battery Council International Standard BCIS-03A (2009 revision), “BCI Recommended Test Methods VRLA-AGM Battery Separators”, method number 8 being “Surface Area.” Following this technique, the BET surface area is measured via adsorption analysis using a BET surface analyzer (e.g., Micromeritics Gemini II 2370 Surface Area Analyzer) with nitrogen gas; the sample amount is between 0.5 and 0.6 grams in a ¾″ tube; and, the sample is allowed to degas at 75° C. for a minimum of 3 hours.

The basis weight, or grammage, of the separator can range from approximately 15 gsm to approximately 500 gsm. In some embodiments, the basis weight ranges from between approximately 20 gsm to approximately 100 gsm. In some embodiments, the basis weight ranges from between approximately 100 gsm to approximately 200 gsm. In some embodiments, the basis weight ranges from approximately 200 gsm to approximately 300 gsm. In some embodiments, the basis weight of pasting paper, described below, including the surface modified fibers, ranges from between approximately 15 gsm to approximately 100 gsm. The basis weight or grammage is measured according to method number 3 “Grammage” of Battery Council International Standard BCI5-03A (2009 Rev.) “BCI Recommended test Methods VRLA-AGM Battery Separators.”

In some embodiments, the thickness of the separator can vary. The thickness of the separator in a battery can range from greater than zero to approximately 5 millimeters. The thickness of the separator can be greater than or equal to approximately 0.1 mm, approximately 0.5 mm, approximately 1.0 mm, approximately 1.5 mm, approximately 2.0 mm, approximately 2.5 mm, approximately 3.0 mm, approximately 3.5 mm, approximately 4.0 mm, or approximately 4.5 mm; and/or less than or equal to approximately 5.0 mm, approximately 4.5 mm, approximately 4.0 mm, approximately 3.5 mm, approximately 3 mm, approximately 2.5 mm, approximately 2.0 mm, approximately 1.5 mm, approximately 1.0 mm, or approximately 0.5 mm. In some embodiments, the thickness of pasting paper, described below, including the surface modified fibers, ranges from between approximately 0.1 mm to approximately 0.9 mm. The thickness is measured according to method number 12 “Thickness” of Battery Council International Standard BCI5-03A (2009 Rev.) “BCI Recommended test Methods VRLA-AGM Battery Separators.” This method measure the thickness with a 1 square inch anvil load to a force of 10 kPa (1.5 psi).

The glass fibers disclosed may have application beyond the described battery separators. For example, the surface modified fibers may be used in other aspects of battery construction (e.g., as components in pasting paper). Pasting paper is manufactured in a similar paper-making manner as described for the battery separators. Pasting paper, generally, may have a lower basis weight, and be thinner, as compared to the battery separators. The pasting paper is used in electrode plate construction, described below. Some electrode plates are constructed from an aqueous lead oxide paste applied to a grid. The pasting paper is used to retain the shape of the plate while the paste dries. The pasting paper may also be used to cover an electrode plate before installation in a battery, or in application of an active material to the plate.

### Batteries—Generally

The other components of the battery can be conventional components. Anode plates and cathode plates can be formed of conventional lead acid battery electrode materials. For example, in container formatted batteries, plates, can include grids that include a conductive material, which can include, but is not limited to, lead, lead alloys, graphite, carbon, carbon foam, titanium, ceramics (such as Ebonex®), laminates and composite materials. The grids are typically pasted with lead-based active materials. The pasted grids are typically converted to positive and negative battery plates by a process called “formation.” Formation involves passing an electric current through an assembly of alternating positive and negative plates with separators between adjacent plates while the assembly is in a suitable electrolyte. In some embodiments, battery is one-shot formed, wherein acid is added to the container only once. For dry charge plates, the plates are placed in acid baths and connected to an electric current.

As a specific example, anode plates contain lead as the active material, and cathode plates contain lead dioxide as the active material. Plates can also contain one or more reinforcing materials, such as chopped organic fibers (e.g., having an average length of 0.125 inch or more), metal sulfate(s) (e.g., nickel sulfate, copper sulfate), red lead (e.g., a Pb₃O₄-containing material), litharge, paraffin oil, and/or expander(s). In some embodiments, an expander contains barium sulfate, carbon black and lignin sulfonate as the primary components. The components of the expander(s) can be pre-mixed or not pre-mixed. Expanders are commercially available from, for example, Hammond Lead Products (Hammond, Ind.) and Atomized Products Group, Inc. (Garland, Tex.). An example of a commercially available expander is Texex® expander (Atomized Products Group, Inc.). In certain embodiments, the expander(s), metal sulfate(s) and/or paraffin are present in anode plates, but not cathode plates. In some embodiments, anode plates and/or cathode plates contain fibrous material described in U.S. Patent Application Publication No. 2006/0177730.

A battery can be assembled using any desired technique. For example, separators are wrapped around electrode plates (e.g., cathode plates, anode plates). Anode plates, cathode plates and separators are then assembled in a case using conventional lead acid battery assembly methods. In certain embodiments, separators are compressed after they are assembled in the case, i.e., the thickness of the separators are reduced after they are placed into the case. An electrolytic mixture (e.g., just sulfuric acid, or sulfuric acid and silica) is then disposed in the case.

In the case of gelled electrolyte batteries, silica can be added to the electrolyte mixture. The silica can be colloidal silica, fumed silica, precipitated silica, and/or never dried precipitated silica, for example. The silica concentration can be adjusted so that, after the sulfuric acid is absorbed by the separator, the silica can gel with the sulfuric acid external to the separator.

In some embodiments, fibrous material (e.g., fibers or fiber slurries described in U.S. Patent Application Publication No. 2006/0177730) is added into the case (e.g., in a head space between the top surfaces of plates and the case, between the interior wall of the case and the plates, in one or more anode plates, in one or more cathode plates, in one or more separators, and/or between the sides and bottom of the anode plates and cathode plates). The fibrous material can be added to the case prior to and/or after the addition of the electrolytic mixture into the case. Other methods of adding the fibrous material are described in U.S. Patent Application Publication No. 2006/0177730. The amount of electrolytic mixture that is disposed within the case is sufficient to properly wet separators and, if applicable, to wet (e.g., to saturate) the fibrous material in the case. A cover is then put in place, and terminals are added.

While a number of embodiments have been described, the invention is not limited to these embodiments.

In some embodiments, the separator can include one or more additives. Examples of additives include fillers (e.g., silica, diatomaceous earth, celite, zirconium, plastics). The additives can be used in the range of less than approximately 0.5 percent to approximately 70 weight percent. In some embodiments, which include additives, the separator comprises glass fibers and powdered silica or another powdered material that is inert to battery reactions and materials that are present in a battery. The separator is made, in accordance with the method of this invention, and additives may be added to the separator in the slurry or via an additional headbox.

The electrolytic mixture can include other compositions. For example, the electrolytic mixture can include liquids other than sulfuric acid, such as a hydroxide (e.g., potassium hydroxide). In some embodiments, the electrolytic mixture includes one or more additives, including but not limited a mixture of an iron chelate and a magnesium salt or chelate, organic polymers and lignin, ions of tin, selenium and bismuth and/or organic molecules, and phosphoric acid.

Additional embodiments are disclosed in the following examples, which are illustrative only and not intended as limiting.

### EXAMPLES

### Example 1

### Standard Fiber Comparison

Overall Experimental Design

To evaluate the performance of surface modified glass fibers in a battery an experiment was devised to test the electro-chemical differences between standard glass fibers and the surface modified glass fibers. A test cell was constructed and its performance with both standard and surface modified fibers measured and compared. Specifically, to test the electro-chemical performance the voltage at the negative electrode of the test cell was varied and the current through the cell measured. A rapid change in the current as the voltage increased indicates hydrogen production at the negative electrode. Hydrogen production, in turn, indicates that oxygen is no longer being recombined at the negative electrode thus signaling the maximum ability of the cell to recombine oxygen. The higher the voltage at the negative electrode before hydrogen production, the better performance of the cell.

Materials & Cell Construction

The test cell was constructed in a beaker, 6 cm deep and 8 cm in diameter. A 0.125″ diameter lead wire formed in to a 1″ long coil was used as the positive counter electrode, and to generate oxygen. A 0.25″ diameter lead wire with 0.250″ of exposed length was used as the negative working electrode. The negative electrode was controlled by a mercurous sulfate/mercury reference electrode. The negative electrode voltage was varied from 0.800 V to 1.750 V, as compared to the reference electrode. 400 ml of sulfuric acid solution was used as the electrolyte solution. The electrolyte solution had a specific gravity of 1.26 g/cm³. Different fibers were added to the solution to evaluate their ability to aid oxygen transport. The electrolyte and fibers were stirred using a magnetic stir bar. This procedure is a variation of the Electrochemical Compatibility test issued by the Battery Council International (BCIS-03a Rev. February 02) and is based on AT&T Technology Systems Manufacturing Standard 17000 Section 1241. The experimental setup is different from the BCI method in that the oxygen generating counter electrode is in the same vessel as the working negative electrode.

Experimental/Operational Procedure

The electrodes were conditioned for 10 cycles, varying the negative electrode voltage from 0.800V to 1.750V versus a mercury/mercurous sulfate reference electrode to condition the electrodes and obtain a steady state of dissolved gases in the electrolyte. After ten cycles, an individual voltage scan was performed from 0.8 volts to 1.75 volts as compared to the reference electrode, and the current recorded as the voltage varied. This was the blank scan, or base line, to which the electrochemical response will be compared after the addition of fibers to the electrolyte.

Fiber Addition

0.25 g of fibers were added, either the control fibers or the surface modified fibers individually, to the 400 ml of electrolyte to simulate a glass mat separator in a VRLA battery. A repeat scan was taken after fiber addition and compared to the blank sample to elucidate the affect of the glass fibers on the negative electrode response.

Results

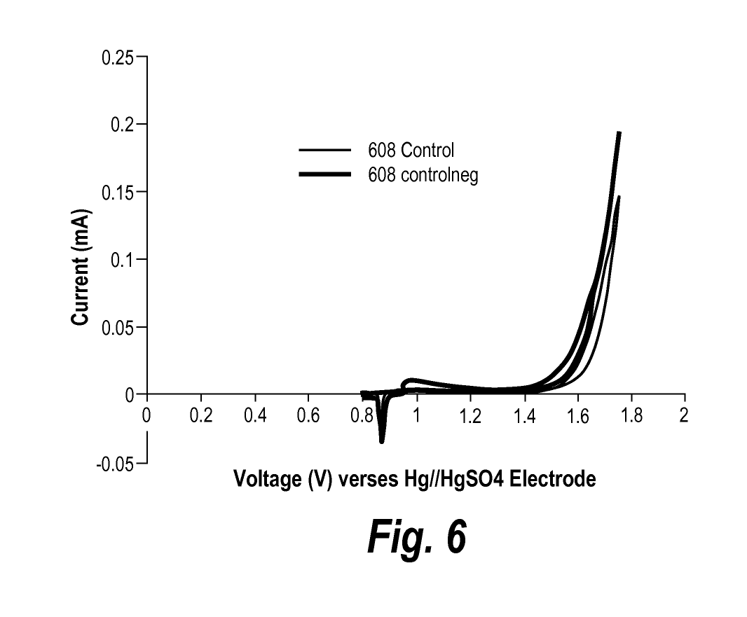

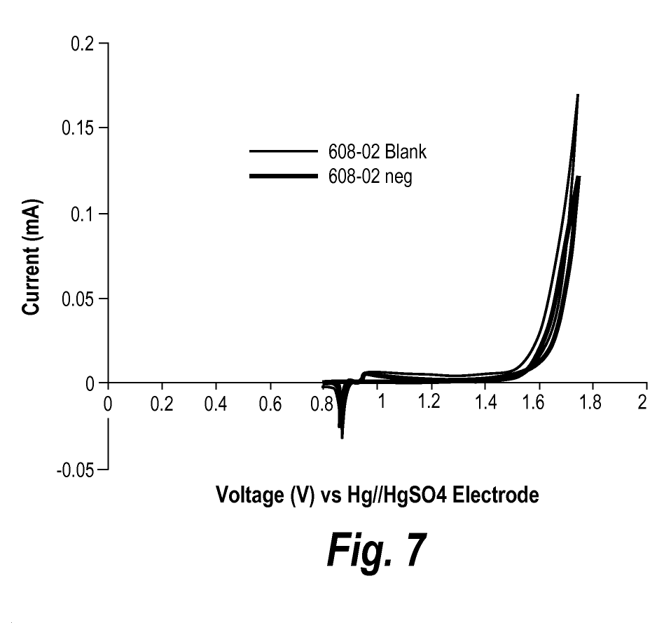

Evanite 608M fibers made by traditional fiberization method are analyzed for oxygen transport and compared to 608M fibers made with oxygen enriched conditions, i.e., surface modified fibers. The results are shown in FIGS. 6 and 7. As can be seen from FIG. 6, the inclusion of the glass fibers made by traditional methods shifts the generation of hydrogen (indicated by the rapid rise in current to the right of the figure) to the left, to a lower voltage. This is mostly due to the impurities introduced into the electrolyte from the fibers. A hydrogen shift of −20 to −60 mV is observed.

Voltage scan results for Evanite 608M fibers made under oxygen enriched conditions, surface modified fibers, are shown in FIG. 7. Here it is noted that the hydrogen evolution is shifted to the right, to a higher voltage, rather than to the left (lower voltage). The surface modified fibers shift the hydrogen evolution to a higher voltage, overcoming trace impurities that are also present in the oxygen enriched fibers, indicating enhanced oxygen recombination at the negative electrode.

### Example 2

### Course Fiber Comparison

Courser diameter fibers (Evanite 609M fibers −˜1.3 micron) made under oxygen enriched conditions were also evaluated against traditional fibers (Johns Manville 206-253 fibers). Again surface modified fibers were shown to delay hydrogen evolution, even above trace contamination levels contributed by the fibers, indicating more efficient oxygen transfer. The 206-253 fiber, like the 608M control fibers showed hydrogen evolution occurring at a lower voltage. All test results are summarized in Table 3.

TABLE 1

| | | Voltage | Voltage of | H2 |
|---|---|---|---|---|
| | Current | of Blank | Test Cell | Generation |
| Sample | (A) | (V) | (V) | Shift (mV) |
| 608M-Control | 0.020 | 1.622 | 1.588 | −34.3 |
| 608M-Control | 0.030 | 1.642 | 1.612 | −29.7 |
| 608M-O₂ | 0.020 | 1.625 | 1.635 | 10.7 |
| (surface modified fibers) | | | | |
| 608M-O₂ | 0.030 | 1.644 | 1.665 | 20.8 |
| (surface modified fibers) | | | | |
| 206-253 | 0.020 | 1.594 | 1.539 | −55.1 |
| 206-253 | 0.030 | 1.619 | 1.568 | −51.1 |
| 609M-O₂ | 0.020 | 1.642 | 1.649 | 6.7 |
| 609M-O₂ | 0.030 | 1.671 | 1.678 | 6.7 |

### Example 3

### XPS Analysis

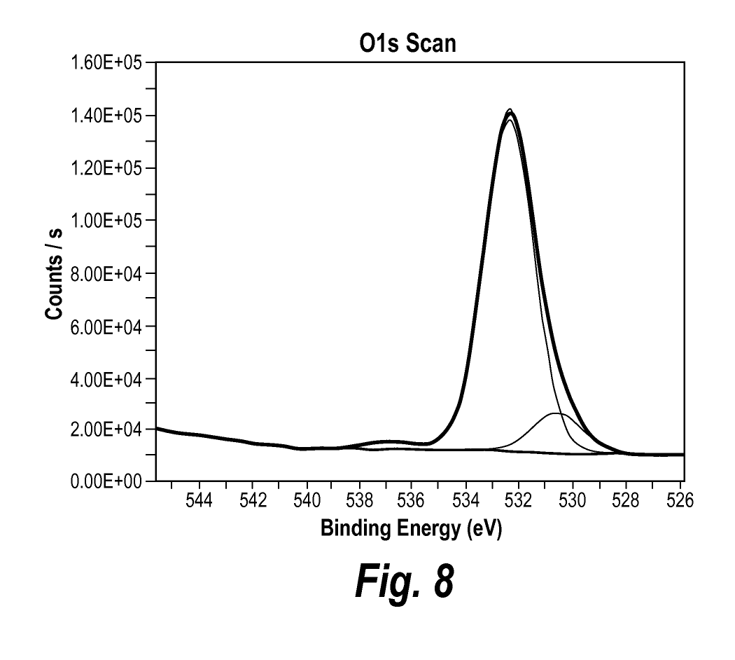

The surface oxygen peak related to SiO₂ at 532.7 eV binding energy were measured using XPS. Spectrums of the 609M control, 609 oxygenated, JM 206 and Lausha C08 were taken on ThermoScientific ESCALAB 250 (ThermoScientific, Waltham, Mass.). 150 eV was used for survey scans and 50 eV for multiplex (composition) scans. The spot size was 400 μm and monochromatized Al x-ray was used as irradiation source. Binding energy scales were adjusted in spectra plots to hydrocarbon in C1s at 284.8 eV. The composition table (Table 4) shows a SiO2 peak corresponding 532.7 eV biding energy, representing the sp3 bonds. The 609M oxygenated glass fiber sample has the maximum concentration when compared to control and Johns Manville 206-253 as well as Lausha C08. Note, values for all fibers have been normalized to 609M. A typical O1s peak fit is shown in FIG. 8.

TABLE 2

| | | | | | | | | | ~537 eV | |
|---|---|---|---|---|---|---|---|---|---|---|
| | | | | | | | | | (π—π | |
| | | | | | | | ~531 eV | SiO2 | bond | Si—O |
| Sample | C | Ca | K | Mg | N | Na | (Si—O⁻—Na+) | (sp3) | interaction) | (2p) |
| 609 | 28 | 0.5 | | | 0.6 | 4.6 | 8.9 | 33.3 | 0.6 | 23.4 |
| Control | | | | | | | | | | |
| 609 | 25.6 | 0.7 | 0.1 | 0.3 | 0.3 | 4.4 | 5.8 | 39.5 | 0.5 | 22.8 |
| Oxygen | | | | | | | | | | |
| JM 206 | 16.6 | 0.5 | | | 0.6 | 6.5 | 5.5 | 33.4 | 1.1 | 24.9 |
| Lausha | 17.7 | 0.3 | | | 0.4 | 5.5 | 5.3 | 32 | 1 | 25.6 |
| C08 | | | | | | | | | | |

Without being bound by any theory, the XPS signals at 531 eV and 537 eV are considered to correspond to bonds in the Si—O⁻—Na⁺system and π-π bond interactions.

1. A composition comprising
glass fibers with a surface atomic concentration of oxygen in sp3 bonds with silicon of at least about 34%;
wherein the fibers are in the form of a battery separator.

2. The composition of claim 1, wherein the concentration of oxygen in sp3 bonds with silicon is measured by XPS.

3. The composition of claim 1, wherein the fibers comprise between about 50 weight percent to about 75 weight percent silica, between about 1 weight percent to about 5 weight percent aluminum oxide, and less than about 25 weight percent sodium oxide.

4. The composition of claim 1, wherein the atomic concentration of oxygen in sp3 bonds with silicon is measured to a depth of between about 100 and 150 Angstroms from the surface of the fiber.

5. The composition of claim 1, wherein the surface atomic concentration of oxygen in sp3 bonds with silicon is at least about 35%.

6. The composition of claim 1, wherein the surface atomic concentration of oxygen in sp3 bonds with silicon is at least about 36%.

7. The composition of claim 1, wherein the surface atomic concentration of oxygen in sp3 bonds with silicon is at least about 37%.

8. The composition of claim 1, wherein the surface atomic concentration of oxygen in sp3 bonds with silicon is at least about 38%.

9. The composition of claim 1, wherein the surface atomic concentration of oxygen in sp3 bonds with silicon is at least about 39%.

10. The composition of claim 1, wherein the atomic concentration of oxygen bonded with silicon is at least about 56 percent.

11. The composition of claim 1, wherein the atomic concentration of oxygen bonded with silicon is at least about 58 percent.

12. The composition of claim 1, wherein the atomic concentration of oxygen bonded with silicon is at least about 60 percent.

13. The composition of claim 1, wherein the atomic concentration of oxygen bonded with silicon is at least about 62 percent.

14. The composition of claim 1, wherein the atomic concentration of oxygen bonded with silicon is at least about 64 percent.

15. The composition of claim 1, wherein the fibers comprise between about 60 weight percent and about 70 weight percent silica.

16. The composition of claim 1, wherein the fibers comprise between about 0.5 weight percent and about 30 weight percent bismuth oxide.

17. The composition of claim 1, wherein the fibers have an average diameter between about 0.6 μm and about 8 μm.

18. The composition of claim 17, wherein the fibers have an average diameter between about 0.7 μm and about 1.5 μm.

19. The composition of claim 1, wherein the fibers have an average diameter between about 2.5 μm and about 10 μm.

20. The composition of claim 1, wherein the battery separator has an average thickness between about 0.25 mm and about 4 mm, before placement in a battery.

21. The composition of claim 1, wherein the battery separator has a surface area between about 1.0 m2/g and about 2.5 m2/g.

22. The composition of claim 1, wherein the battery separator has a surface area between about 1.3 m2/g and about 1.6 m2/g.

23. The composition of claim 1, wherein the battery separator further comprises organic fibers.

24. The composition of claim 23, wherein the battery separator further comprises bi-component fibers.

25. The composition of claim 1, wherein the battery separator has a grammage of between about 15 gsm and about 100 gsm.

26. The composition of claim 1, wherein the battery separator has a grammage of between about 140 gsm and about 500 gsm.

27. A battery, comprising:
a first electrode;
a second electrode, wherein at least one of the first and second electrodes comprises lead;
a separator between the first and second electrodes, wherein the separator comprises
glass fibers with a surface atomic concentration of oxygen in sp3 bonds with silicon of at least about 34%; and
an electrolytic solution.

28. The battery of claim 27, wherein the concentration of oxygen in sp3 bonds with silicon is measured by XPS.

29.-30. (canceled)

31. The battery of claim 27, wherein the surface atomic concentration of oxygen in sp3 bonds with silicon is at least about least about 35%.

32. The battery of claim 27, wherein the surface atomic concentration of oxygen in sp3 bonds with silicon is at least about least about 36%.

33. The battery of claim 27, wherein the surface atomic concentration of oxygen in sp3 bonds with silicon is at least about least about 37%.

34. The battery of claim 27, wherein the surface atomic concentration of oxygen in sp3 bonds with silicon is at least about least about 38%.

35. The battery of claim 28, wherein the surface atomic concentration of oxygen in sp3 bonds with silicon is at least about least about 39%.

36. The battery of claim 27, wherein the atomic concentration of oxygen bonded with silicon is at least about 56 percent

37.-47. (canceled)

48. A composition comprising
glass fibers with a surface atomic concentration of oxygen in sp3 bonds with silicon of at least about 34%;
wherein the fibers are in the form of pasting paper.

49. The composition of claim 48, wherein the concentration of oxygen in sp3 bonds with silicon is measured by XPS.
